(19) United States
(12) Patent Application Publication
(10) Pub. No.: US 2015/0007502 A1
(43) Pub. Date: Jan. 8, 2015

(54) Concealed Insect Screen

(71) Applicant: John Poppema, Langley (CA)

(72) Inventor: John Poppema, Langley (CA)

(21) Appl. No.: 14/324,619

(22) Filed: Jul. 7, 2014

Related U.S. Application Data
(60) Provisional application No. 61/843,310, filed on Jul. 5, 2013.

(51) Int. Cl. E06B 9/52; E06B 7/14; E06B 1/70

(52) U.S. Cl. CPC E06B 9/522; E06B 1/70; E06B 7/14
USPC 49/469; 49/471; 160/84.02

(57) ABSTRACT

The swing door assembly disclosed herein is formed and assembled to keep fluids (liquids) in particular (rain) water out of a building such as a home or business. An interoperating accordion screen is also disclosed. Several examples will be provided demonstrating a door that swings inward, a door that swings outward, and an example of each with an accordion style screen provided in the door assembly. Such accordion-style screen assemblies have been known to cause significant problems in transfer of fluid away from the exterior surface of the door and building due in part to the alignment channels needed to keep the accordion screens in proper position when closed.

This application claims priority to U.S. Provisional Patent Application 61/843,310 filed on Jul. 5, 2013 incorporated herein by reference.

### BACKGROUND OF THE DISCLOSURE

### Field of the Disclosure

This disclosure relates to the field of concealed insect screens and door sills for exterior doors with fluid passageways and channels to direct fluid away from the exterior surface of the door.

### SUMMARY OF THE DISCLOSURE

Disclosed herein are several examples of door sills and screens for exterior entry doors. Many of these examples can be arranged in combinations not specifically described or shown in the drawings.

In one example is disclosed an exterior door sill for fluid transfer away from an exterior surface of an exterior door having a lateral width, vertical height, and transverse depth, the door sill comprising: the exterior door sill extending the lateral width of the door, positioned substantially below the door and having a first lateral fluid channel below an exterior surface of the door; wherein the forward surface of the lateral fluid channel forms a first lateral bulkhead having at least one surface defining a first transverse fluid passageway therethrough; a tread portion extending transversely forward of the door; a second transverse fluid passageway below the tread portion; wherein the forward surface of the lateral fluid channel forms a second lateral bulkhead having at least one surface defining a second transverse fluid passageway there through laterally offset from the first transverse fluid passageway; wherein fluid flows below an upper surface of the exterior door sill and above an upper surface of the exterior door sill from the first lateral fluid channel transversely through the first transverse fluid passageway, laterally through the second lateral fluid channel and transversely through the second transverse fluid passageway transversely away from the exterior surface of the door.

In one example, the sill includes: a lateral accordion screen door channel; a surface defining a third lateral fluid channel below the screen door channel; wherein the screen door channel is in fluid communication with the third lateral fluid channel so that fluid flows from the screen door channel to the third lateral fluid channel by gravity.

The exterior door sill may be arranged wherein the door further comprises hinges on the exterior surface of the door so as to permit the door to swing outwardly.

The exterior door sill may further comprise a lateral accordion screen channel on the exterior side of the door.

The exterior door sill may be arranged wherein the door further comprises hinges on the interior surface of the door so as to permit the door to swing inward.

The exterior door sill may further comprise a lateral accordion screen channel on the exterior side of the door.

The exterior door sill may be arranged wherein the screen door channel comprises a removable channel cover receiving surface.

The exterior door sill may further comprise a removable channel cover removably fitted to the cover receiving surface.

The exterior door sill may be arranged wherein at least one portion of the door sill is functional as a door sill when vertically inverted.

The exterior door sill may be arranged wherein the door sill comprises a plurality of interoperating and removably interconnected portions substantially extending the lateral width of the door sill.

The exterior door sill as recited in claim 10 wherein each of the interoperating and removably interconnected portions is an extruded component.

The exterior door sill may be arranged wherein the door sill comprises a removable tread portion positioned directly below the door.

The exterior door may comprise a continuous malleable seal around the doorway.

A screen assembly is also disclosed comprising: a pleated accordion screen having a first lateral side attached to a doorway; the accordion screen having a second lateral side repositionable from an open position adjacent the first lateral side to a closed position at an opposing lateral side of the doorway; at least one laterally aligned surface defining a string void through each pleat of the accordion screen; a string a string passing though each laterally aligned string void; the string having one end attached to a counterbalance weight facilitating closing of the screen assembly.

The screen assembly may further comprise; a sill positioned below the pleated accordion screen; a lateral accordion screen channel in the sill; a surface defining a lateral fluid channel below the screen channel; wherein the screen channel is in fluid communication with the lateral fluid channel so that fluid flows from the screen channel to the lateral fluid channel by gravity.

The screen assembly may further comprise; a slide bar attached to the second lateral side of the accordion screen; a carriage suspended from a channel attached to a doorway adjacent the screen assembly; and wherein the slide bar is attached to and suspended from the carriage.

The screen assembly may be arranged wherein the carriage comprises at least one string wheel around which the string traverses between the accordion screen and a weight suspended by the string below the carriage inside the slide bar.

The screen assembly may be arranged wherein the carriage comprises at least one balance wheel set at an offset angle to the channel wherein the balance wheel redirects the string for use through at least two sets of laterally aligned surfaces defining a string voids through each pleat of the accordion screen.

The screen assembly may further include a sting tie down comprising: a surface defining a vertical void there through; a plurality of indexing surfaces on a lower region thereof; and a plurality of cleats extending horizontally from the exterior surface thereof.

The screen assembly may be arranged wherein: the screen is interior of an exterior entry door; the entry door opens outward.

### BRIEF DESCRIPTION OF THE DRAWINGS

FIG. 1 is a front isometric view of one example of the disclosed apparatus.

FIG. 2 is a side detail enlarged view of the example shown in FIG. 1 with several exterior components removed to show the inner structure.

FIG. 3 is a right side cutaway view taken along line 3-3 of FIG. 1.

FIG. 4 is a left side enlarged detail view of the example shown in FIG. 1

FIG. 5 is a left side of the example shown in FIG. 1 with several exterior components removed to show the inner structure.

FIG. 6 is a left side isometric cutaway view showing components of one example of an accordion style concealed insect screen latching system.

FIG. 7 is a front cutaway view taken along line 7-7 of FIG. 5.

FIG. 8 is a front cutaway view taken along line 8-8 of FIG. 5.

FIG. 9 is a front cutaway view taken along line 9-9 of FIG. 5.

FIG. 10 is a front cutaway view taken along line 10-10 of FIG. 5.

FIG. 11 is an enlarged view of a region of FIG. 9.

FIG. 12 is an enlarged portion of the top isometric cutaway view of FIG. 13 showing drainage flow lines.

FIG. 13 is a top isometric cutaway view showing flow lines of one variation of the apparatus shown in FIG. 12.

FIG. 14 is a front isometric view of one example of the disclosed apparatus.

FIG. 15 is a side detail enlarged view of the example shown in FIG. 14 with several exterior components removed to show the inner structure.

FIG. 16 is a side cutaway view taken along line 16-16 of FIG. 14.

FIG. 17 is an isometric cutaway front view of one section of one example of the disclosed apparatus.

FIG. 18 is an isometric side view of the example shown in FIG. 17.

FIG. 19 is a bottom isometric view of the example shown in FIG. 17.

FIG. 20 is a top cutaway view of one example of an accordion screen assembly.

FIG. 21 is a front isometric cutaway view of a region of the example of FIG. 20.

FIG. 22 is a front isometric cutaway view of a region of the example of FIG. 20.

FIG. 23 is a detail exploded view of a region of FIG. 21.

FIG. 24 is an end (side) cutaway detail view of the example of FIG. 20.

FIG. 25 is another view of the carriage portion of the example shown in FIG. 20.

FIG. 26 is a bottom view of the carriage shown in FIG. 25.

FIG. 27 is an isometric cutaway view of the carriage shown in FIG. 25.

FIG. 28 is a side cutaway view of the carriage shown in FIG. 25.

FIG. 30 is an end view of the assembly shown in FIG. 25.

FIG. 29 is a side cutaway view of the apparatus.

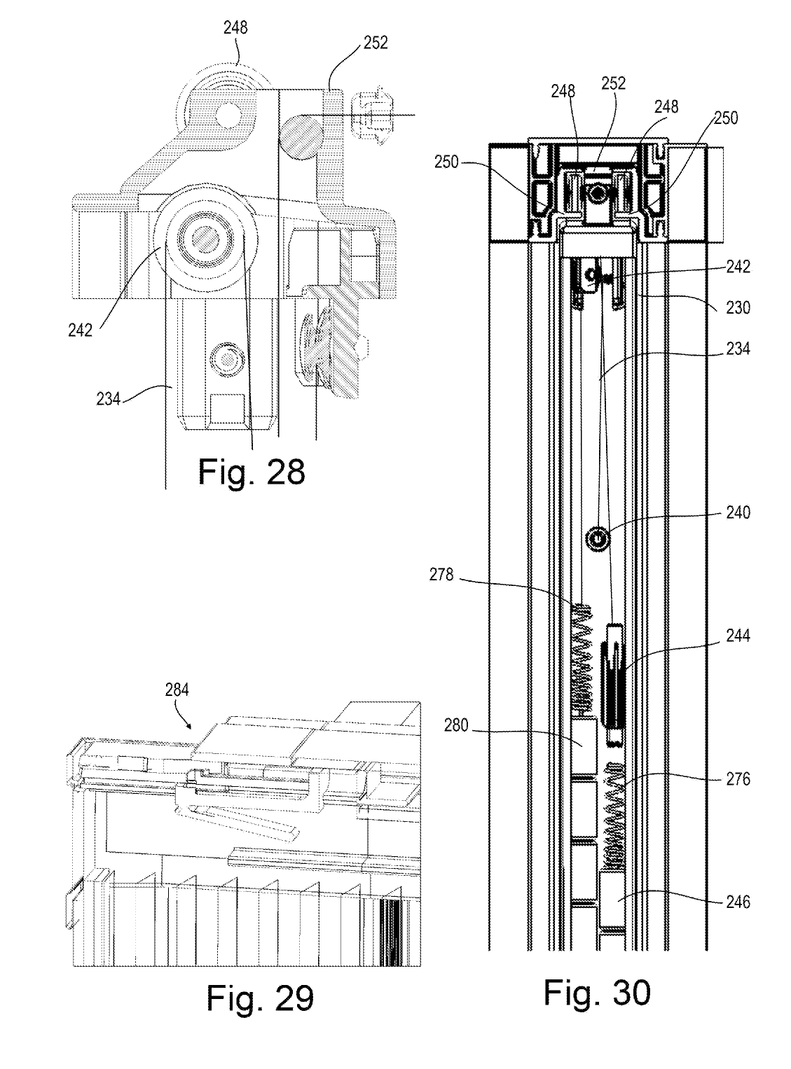

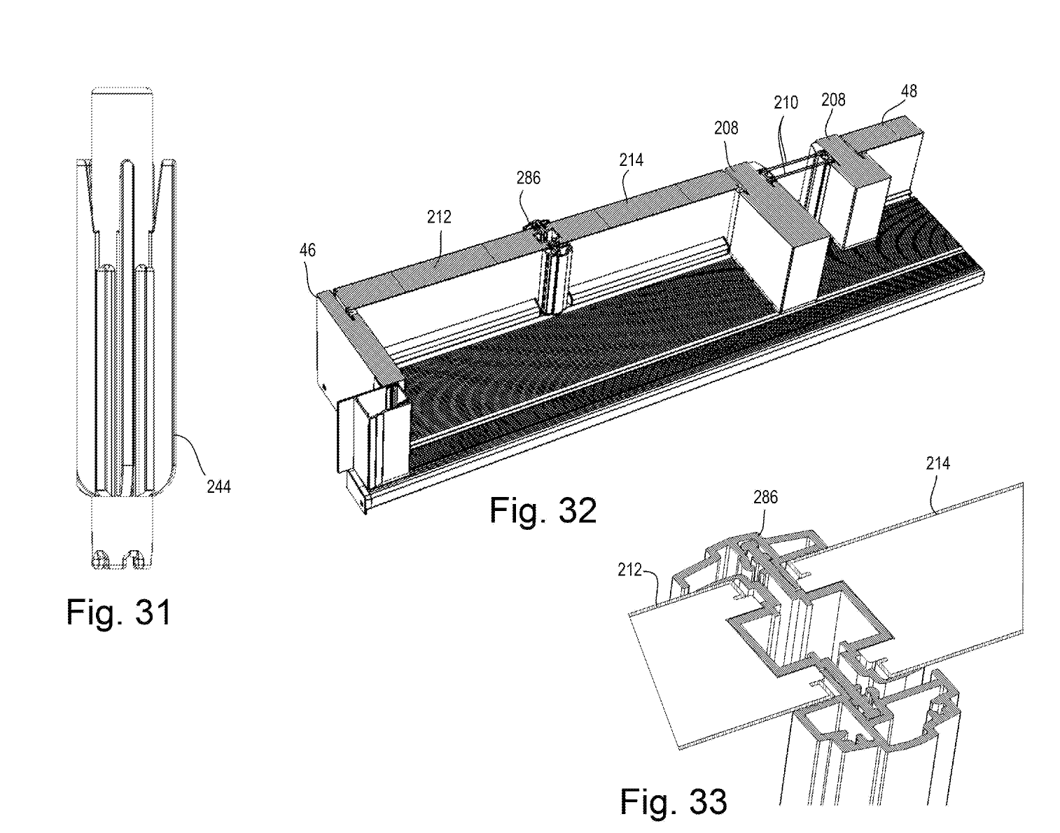

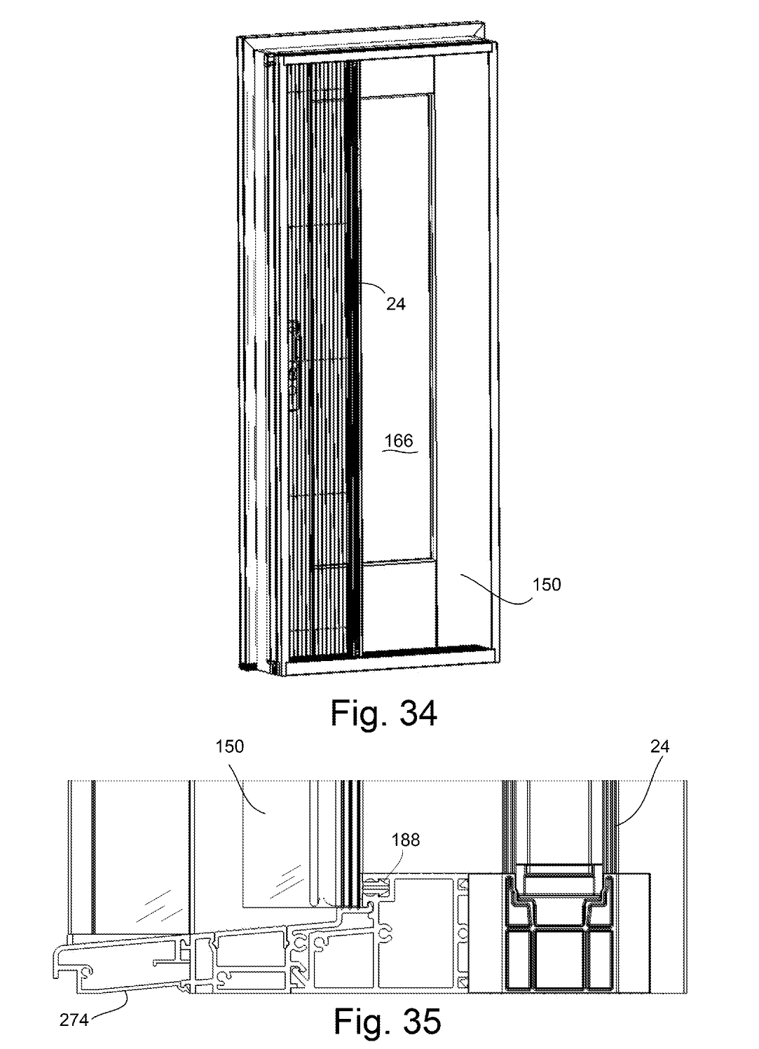

FIG. 30 is an end view of the apparatus.

FIG. 31 is a detail enlarged view of one example of the string tie down component.

FIG. 32 is a top isometric cutaway view of another example showing an astragal.

FIG. 33 is a detail enlarged view of the doors and astragal shown in FIG. 32.

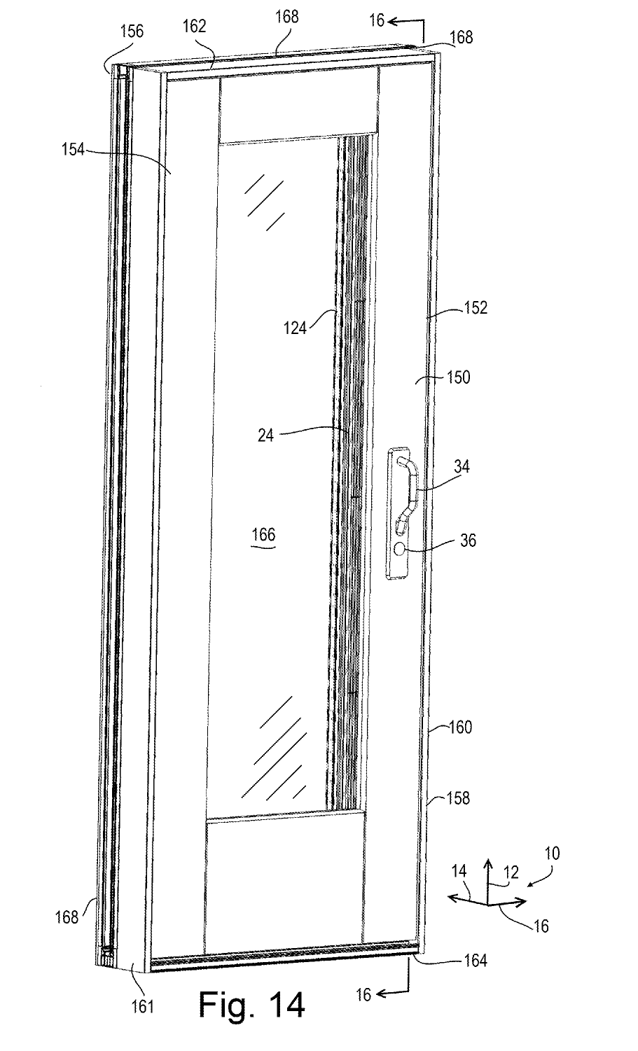

FIG. 34 is a view of the interior side of the example of FIG. 14.

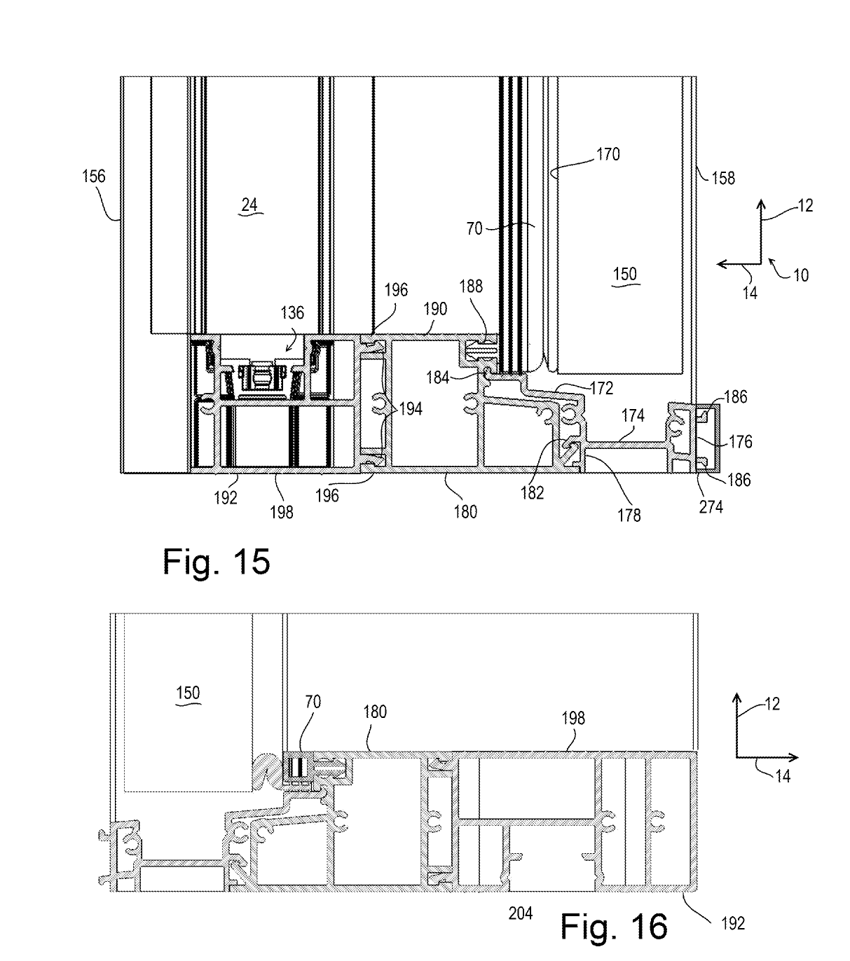

FIG. 35 is a reverse side view of the example shown in FIG. 15 with additional components attached.

### DESCRIPTION OF THE PREFERRED EMBODIMENTS

The swing door and optional accordion screen assembly disclosed herein is formed and assembled to keep fluids (liquids) in particular (rain) water out of a building such as a home or business. While such fluids are commonly presented in the form of rain, snow, sleet, hail, condensation of water vapor, and other precipitation, water from a sprinkler, etc. The term fluid is used as a term encompassing all such heavier-than-air fluids listed above and equivalents.

The disclosed apparatus in several examples is useful where the fluid can cause damage to the building and contents in addition to being a nuisance to occupants. While outward swinging exterior doors without a screen channel are easily provided with an inner step and seal to keep liquid out of the building, exterior inward swing doors, slide doors, and door sills with a screen or other outer channel are somewhat more difficult to manufacture with a low tolerance for fluid entry.

Several examples will be provided demonstrating a door that swings inward, a door that swings outward, and an example of each with an accordion style screen provided in the door assembly. Such accordion-style screen assemblies have been known to cause significant problems in transfer of fluids away from the exterior surface of the door and building.

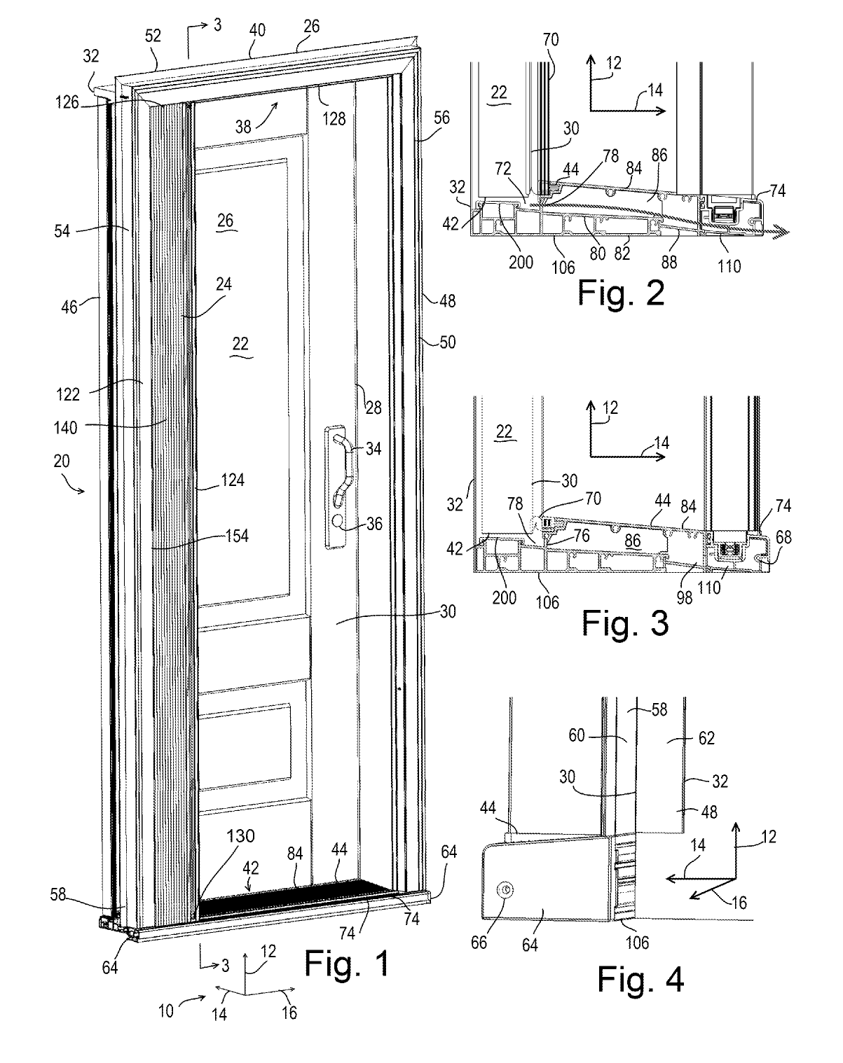

Before continuing with a detailed description of the examples shown herein, an axes system 10 will be defined with a vertical axes 12 shown in FIG. 1 pointing in an upwards direction with the opposing direction directed downward, a transverse axis 14 pointing in a rearward direction with the opposing direction directed forward relative to the forward surface or exterior 30 of the frame of an exterior swing door 22. Also disclosed is a lateral axis 16 pointing in a left direction with the opposing direction directed in a right direction. These axes are provided for consistency sake and for ease in description. While these axes are shown in a normal position for an exterior swing style door in a closed position, it is understood that the door assembly and each component disclosed herein may be provided in other orientations. These axes and directions are not intended to limit the claimed invention to a particular orientation, although the examples may best suit their intended operation when positioned according to these axes and directions.

Beginning with a description of the FIG. 1, the door assembly 20 is shown in one example comprising an inwardly swinging exterior door 22, an accordion mesh screen 24 wherein each of the swinging door 22 and accordion screen 24 are fitted to a frame 26 (door jamb). As with most swing doors 22, one lateral (left to right) side of the door defines a hinge side 154 which is normally coupled to the frame 26 by way of a plurality of hinges. The opposing lateral side of the door commonly defines a latch side 28. In the transverse (front to back) direction, the swinging door 22 comprises an exterior side 30 facing the exterior of the building and an interior side 32 (see FIG. 2) facing the interior of the building. The latch side 28 in one example comprises a handle (latch) 34 or doorknob adjacent to or including a lock 36. The latch and/or lock selectively prohibits or permits entry into the building. The swinging door 22 comprises a vertically upward end 38 adjacent the header 40 of the frame 26 and a lower end 42 adjacent the sill 44 of the frame 26. FIG. 1 also shows the frame 26 comprising a right side frame/jam 46 and a left side frame/jam 48 vertically extending between the header 40 and the sill 44. As shown in FIG. 1, the frame 26 may also comprise or be attached to a fascia 50 comprising an upper component 52 a right side component 54 and a left side component 56 where the left and right side components 54/56 extend vertically between the sill 44 and the upper component 52. FIG. 4 shows an example with an end (side) cap 58 removably positioned on and attached to each lateral end of the sill 44.

As shown in the example of FIG. 1, the fascia 50 may extend vertically above and laterally (left and right) outward of the frame 26 providing an overlap 58 more easily seen in FIG. 4. This overlap enhances control of fluid entry past the door assembly 20. As shown in this example, the transverse rearward side 60 (see FIG. 4) of the overlap 58 is attached to the exterior surface of the building adjacent an opening (doorway) provided for the door assembly 20. The laterally outward side 62 of the side frame 48 engages the laterally inward side of the opening provided for the door assembly 20. A malleable/deformable sealant is generally disposed between these surfaces to control fluid entry (water and air). Often gelatinous weatherproof sealants comprising silicone are used which cure to a semi-rigid state. In the example shown in FIG. 4, the end cap 64 is provided with a screw void 66 through which a threaded screw may be passed to engage a receiver 68 (see FIG. 3) in the sill 44.

Looking to FIG. 2, the lower region of the right lateral side of the door assembly 20 is shown with the end cap 64 and right side jam 46 removed to show the structures there within. In particular, it can be seen how a malleable door gasket 70 may be provided between the sill 44 and the outward surface 30 of the door 22. In addition, the door gasket 70 may extend upward to seal between the door gasket 70 and the side frames 46/48 and header 40. In one form, a continuous unitary door gasket 70 may be utilized. For example, the door assembly 20 may be arranged to allow for a door gasket which bends around the corners where frame/sill/header portions meet. In one form, the gasket may have two ends which contact and may be sealed to each other to form a unitary rectangular structure when assembled. When the door 22 is in the closed position as shown in FIGS. 1-4 there should be substantially no fluid entry between the door 22 and the frame/sill/header. As there may be some fluid entry, such as when the door is opened, a fluid channel 72 may be provided forward of an inner tread 200 and rearward of a first lateral bulkhead 76. This fluid channel will collect fluid and direct it outward of the sill assembly.

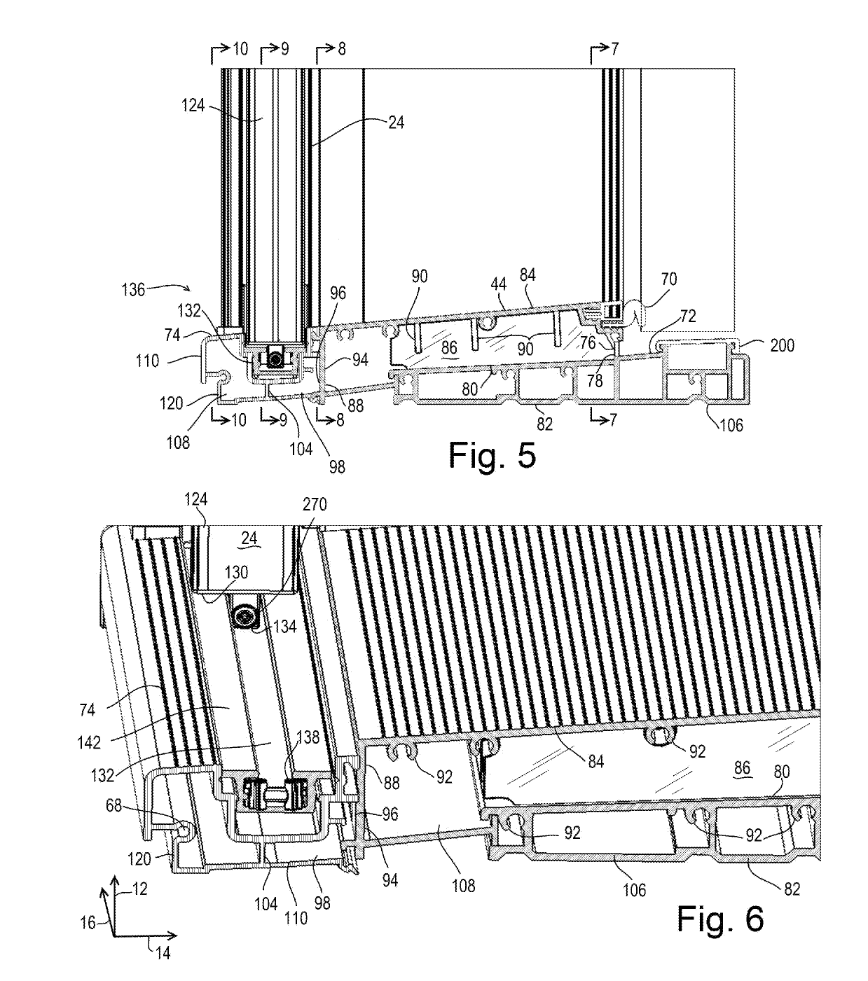

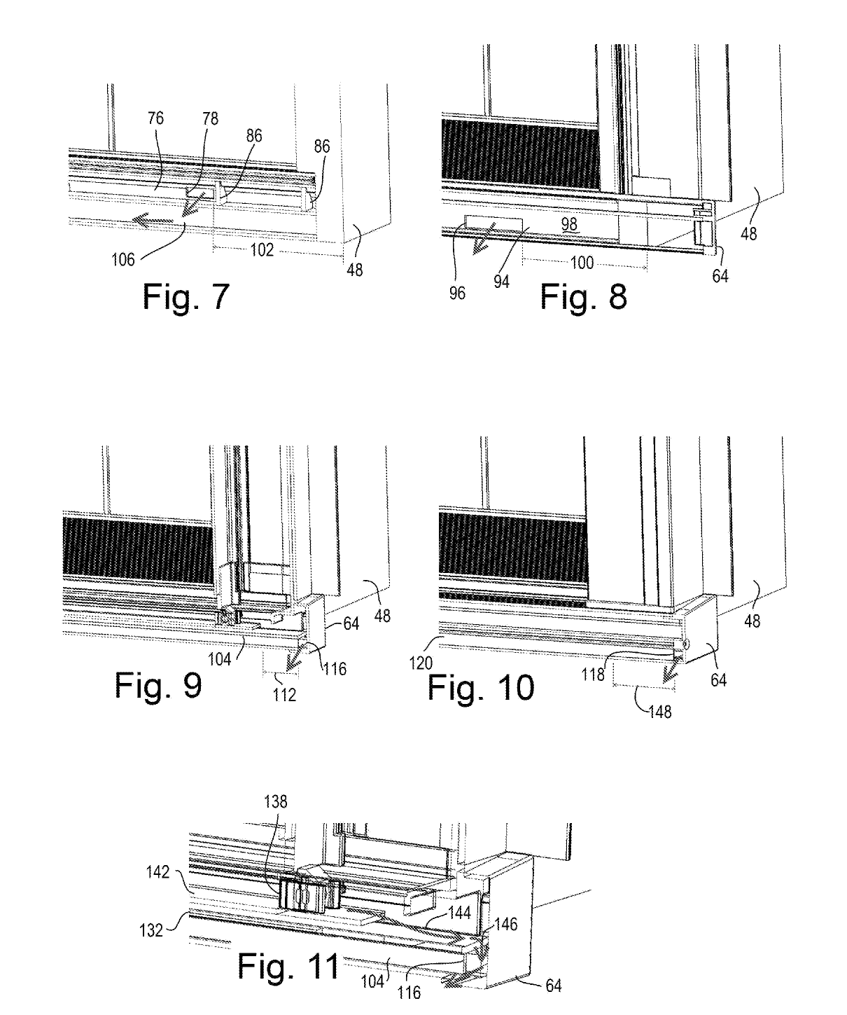

In one form shown in FIG. 3, the inner tread 200 is provided as a removable component (cap) attached to a first extrusion 106 as can be easily understood by looking to FIG. 5. By providing the inner tread portion 200 as a removable component, it can be easily replaced when worn out or damaged.

In the example shown in FIG. 3, the first extrusion 106 also forms the fluid channel 72 and the bulkhead 76. The term bulkhead is used herein to define a partition or wall built to prevent the passage of air, water, or mud. To allow for fluid transfer away from the exterior surface 30 of the inswing door 22; surfaces defining first transverse fluid passageway(s) 78 may be provided in the bulkhead 76 portion of the first extrusion 106. In one form, a panel 80 may be provided transversely forward of the passageway(s) 78 and vertically above a lower surface 82 of the sill 44. The sill 44 in this example further comprises a tread 84 vertically above the panel 80 to form a fluid passageway transversely forward of the passageway(s) 78 and generally angled vertically downward from the door gasket 70 below the tread 84 transversely forward so as to allow fluid there within to flow away from the door 22 by gravity. In one form, the tread 84 is provided as a portion of a second extrusion 88 so as to be removably attached to the first extrusion 106 to allow for ease and replacement, facilitate construction, and to facilitate installation of (removable) transverse supports 86 which provide rigidity and structural support to the tread 84. As persons will be repeatedly stepping upon the tread 84 portion of the sill 44 with significant body weight, such support 86 is clearly beneficial. In addition, a plurality of lateral ribs 90 may be provided to intersect the transverse supports 86 and add additional rigidity and support to the tread 44.

FIG. 6 further shows that the tread surfaces 84, 74, and 200 of FIG. 5, in one form may comprise a friction enhancing surface to reduce slippage of feet and shoes thereupon. In addition, each of the extrusions may comprise lateral and transverse ridges 92 for positioning of supports 86 as well as to facilitate attachment of the end panels such as end cap 64 (FIG. 4) and frame 46 (FIG. 1) thereto as previously described relative to the screw void 66.

Looking to FIG. 5, it can be seen how the second extrusion 88 in one form comprises a second lateral bulkhead 94. Looking to FIG. 8, is shown how at least one second transverse fluid passageway 96 may be provided through the second lateral bulkhead 94. This fluid passageway 96 providing fluid transfer from the fluid passageway 108 to a third lateral fluid chamber 98. This figure also clearly shows an example wherein the second transverse fluid passageway 96 is provided at a second lateral offset 100 which may be substantially larger than a first lateral offset 102. This lateral offset measured between the laterally outward portion of the doorframe 48 and the outermost edge of the first transverse fluid passageway 78. This offset positioning reduces the likelihood of a “soft spot” forming in the tread 84 by the transverse passageways being linearly (transversely) aligned.

Before continuing with a description of the sill, a brief description of the accordion screen assembly will be provided. This brief description will provide some background to the description of the remaining sill components.

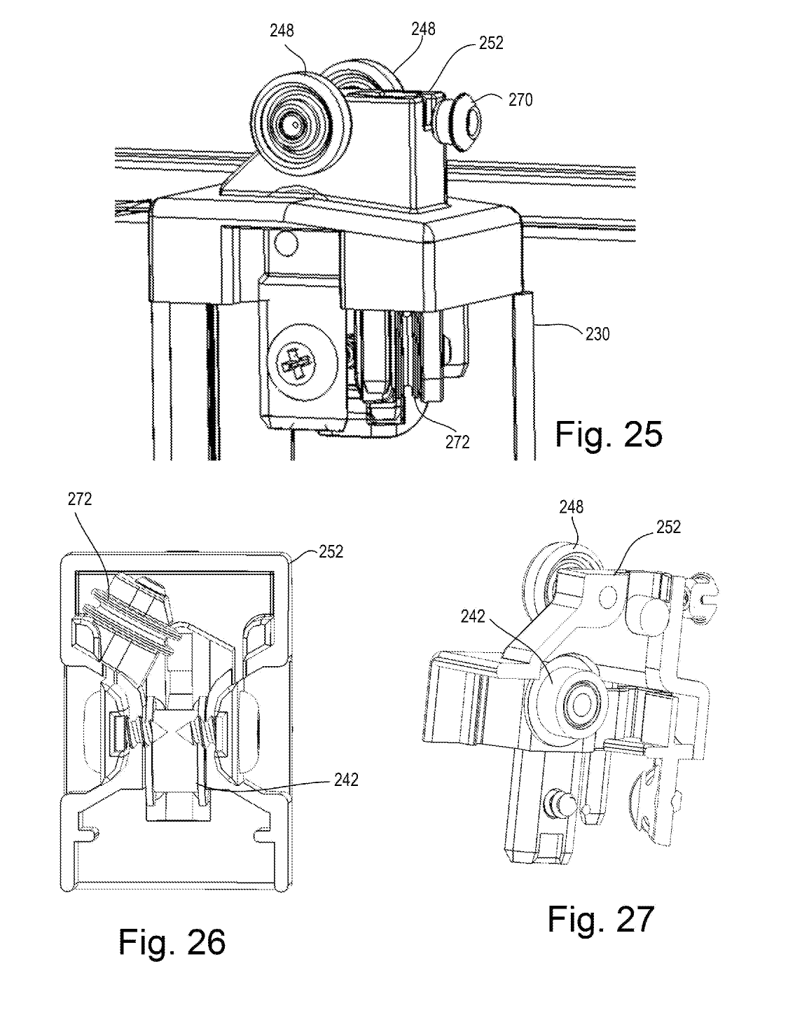

In an example where FIG. 5 represents an installation to a 6″ thick wall commonly found with 2″×6″ construction, it can be appreciated that in a 4″ thick wall commonly found in 2″×4″ construction offsets will need to be provided. In one example, if the same sill angle is requested, then a thinner (4″) wall structure will result in a vertical offset of the screen assembly from that shown here. In one example, adjustments may be made within the carriage 252 (FIG. 25) to provide adjustability to the vertical offset. FIG. 6 further shows a fourth lateral bulkhead 104 positioned forward of the third lateral fluid passageway 98. As fluid flows from the channel 72, in one form the fluid will flow by gravity transversely through the passageway 78, transversely down the upper surface of panel 80, laterally along the second lateral channel 108, transversely through the passageway(s) 96 into a third lateral channel 98 rearward of the fourth lateral bulkhead 104. In one form, as seen in FIG. 6, the third lateral fluid channel 98 and fourth lateral bulkhead 104 are provided as a third extrusion 110 attached to the second extrusion 88.

As can be seen in FIG. 9, a third transverse fluid passageway 116 may be provided through the fourth lateral bulkhead 104 to allow fluid to flow transversely between the third lateral fluid channel 98 to a fourth lateral fluid channel 108. In this example, the third transverse passageway 104 is at a third lateral offset 112 from the outward side of the door frame 48 in an opposing direction from the distances 100 and 102 relative to the outward side of the door frame 48. In simpler terms, while the example shows first and second transverse passageways 78 and 96 inward of the door frame 48, the third transverse passageway 116 is outward of the door frame 48.

In FIG. 10, a fifth lateral bulkhead 120 is provided transversely forward of the fourth lateral bulkhead 104. A surface defining a fourth transverse fluid passageway 118 is provided to allow fluid transfer through the fifth lateral bulkhead 120. In example shown in FIG. 10, the fourth transverse fluid passageway 118 is provided directly forward of the third transverse fluid passageway 116. As the fifth lateral bulkhead 120 is relatively close in a transverse direction to the fourth lateral bulkhead 104, it may be desired to provide little or no lateral offset between these openings 118/116. In the example of FIG. 10, the fourth lateral offset 148 is substantially identical to the third lateral offset 112. In the example shown, the fifth lateral bulkhead 120 is generally viewable from the front of the overall apparatus.

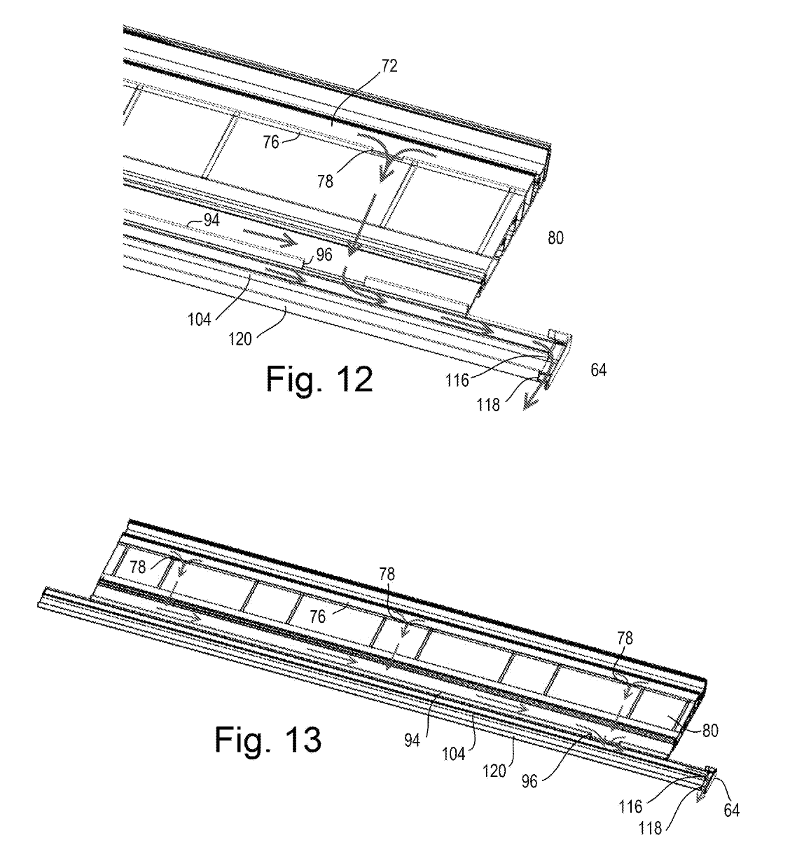

FIG. 12 shows one example of a flow pattern through the apparatus. FIG. 13 shows the same example apparatus with a plurality of fluid passageways 78 through the first lateral bulkhead 76 and only one of each of the fluid passageways 96/116/118 through the second, third, fourth fluid passageways 94/104/120 respectively. Clearly, additional fluid passageways in different arrangements may be provided.

As it may be desired not to have water flow into the region upon which someone entering the building may step (the area directly in front of the lateral center region of the door 22), it may be desired to utilize one of the examples shown wherein fluid flows forward out of the sill 44 only at the outer lateral edge(s) of the apparatus through transverse passageway(s) 118.

As previously mentioned in relation to FIG. 1, in one example the apparatus comprises an accordion screen 24 having a first lateral side 122 fixed to the frame 46 and a second lateral side 124 which extends toward the frame 48 at the opposing lateral side of the doorway. In some installations, the accordion screen 24 will be attached to the frame 46 at the side opposing the handle 34 to facilitate entry into the building through the door 22. In the examples shown, the upper side 126 of the accordion screen 24 slides or rolls within an upper channel 128 provided in the frame 26, the lower side 130 of the screen 24 slides or rolls within a channel 132 which is formed within the third extrusion 110 although it may be formed in other ways.

As shown for example in FIG. 6, the accordion screen 24 may comprise a first portion 134 of a latch system 136. In this example, the first portion 134 of the latch system 136 comprises a bullet or ball-like sting anchor 270. The first portion 134 removably engages a second portion 138 of the latch system 136 fixed to the sill 44. In this specific example, as the first portion 134 engages the second portion 138, elastic jaws of the second portion 138 deform or move outward to allow passage of the largest part of the first portion 134 and then reposition or deform inward to frictionally connect the two portions 134/138 together temporarily until sufficient force is provided in a lateral opening direction to overcome restraining force. The screen may be opened by repositioning the second lateral side 124 toward the first lateral side 122 refolding the accordion screen material 140 as shown in FIG. 1. Other uses for these structures will be described in detail later in this disclosure.

The accordion screen latch system 136 may alternatively utilize magnets, or other latching systems. The second portion 138 of the latching systems couple to the string anchors 270. When the accordion screen is installed, the accordion screen is closed, and the string anchors 270 are retained by the second portion 138 of the latching system 136.

Given the nature and construction of the transversely forward and rearward walls of the channel 132, fluid such as rainwater will generally not be permitted to flow transversely there-past and will tend to accumulate within the channel 132 and flow to the lateral sides thereof.

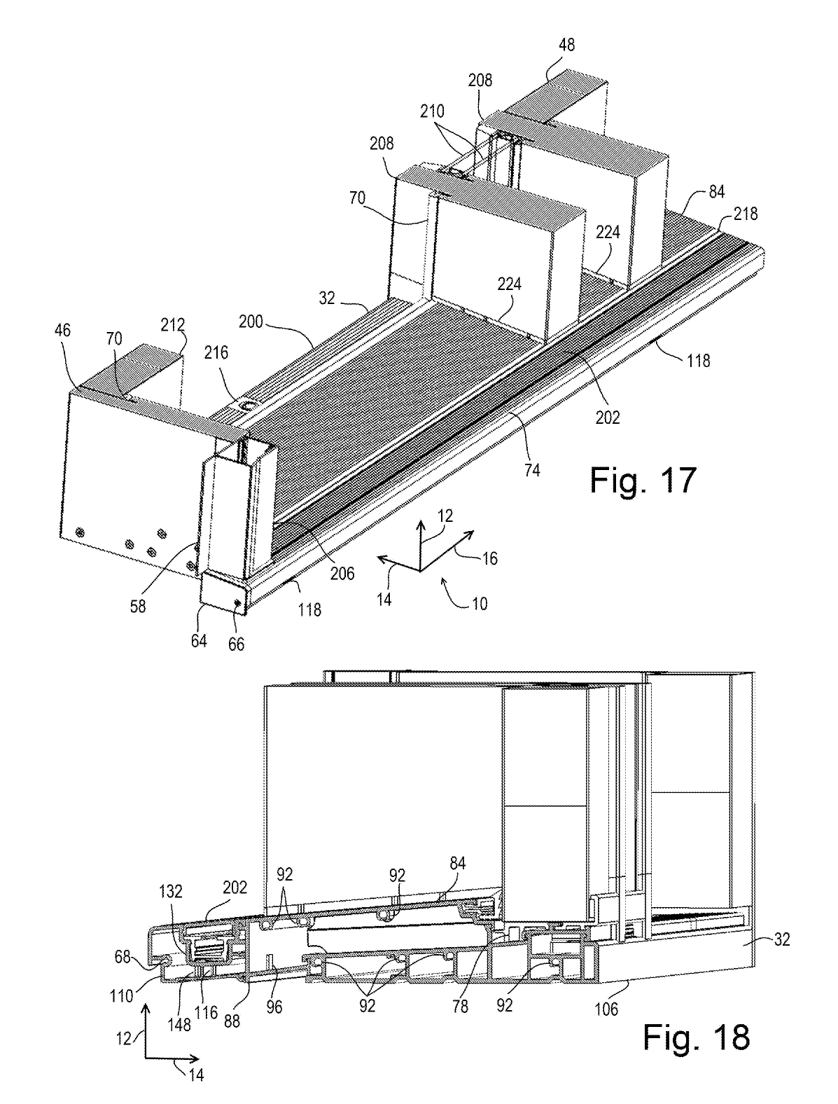

Looking to the example of FIG. 6, it can be seen that an insert 142 may be provided to “snap fit into the channel 132 for ease in construction and replacement thereof. This insert 142 comprises guide surfaces upon which and within which portions of the accordion screen ride to facilitate proper movement during operation. When prolonged periods of disuse may be faced, such as winter months in colder climates, the screen track cover 202 shown in FIGS. 17 and 18 may be utilized to protect the insert 142 and surfaces of the channel 132.

Additional structural support may be provided to the channel 132 and adjacent structures, such as by the fourth lateral bulkhead 104 positioned directly below the channel 132. Looking to FIG. 11, one example of a fluid flow path 144 is shown wherein fluid flows past the insert 142 into the channel 132 and then downward 146 through the third transverse fluid passageway 116. In this example, the fluid will then follow the fluid flow path through the fourth transverse fluid passageway 118 out of the sill onto the surface below the fluid passageway 118. A similar construction may be provided on the opposing lateral side of the channel 132 and/or insert 142.

While the term “extrusion” is used to denote components 88, 106 and 110, it is intended that these components may be formed of other manufacturing methods including 3D printing, casting, machining, etc. Extruding is one way to produce these components as well as other components such as the door frame 25, fascia 50, tread 84, inner tread 200, insert 142, etc. combination construction methods may be employed, such as extruding the components and then machining the transverse passageways and other surfaces.

Looking to FIG. 14 is shown another example of several of the components and assemblies disclosed herein utilized with an outwardly swinging (outswing) door 150 instead of the inswing door shown in the previous example. As with the previous inswing example, the outswing door 150 in one form utilizes a handle 34 and a lock 36 generally adjacent thereto for ease in manipulation and locking of the door 150. These components define a handle side 152 and hinge side 154 of the door 150. Additionally, the door 150 generally comprises an interior transverse side 156 as well as an exterior transverse side 158 when in a closed position. The same axes system 10 is utilized in this example as was used in the first example, however, the accordion screen 24 of this example is shown mounted to the frame 160 on the handle side 152 rather than on the hinge side 154 of the frame 161 as shown in the previous example. This is just one way of mounting the accordion screen 24 to the frame and the accordion screen may alternatively be mounted on the opposing lateral side with relatively few modifications thereto. Additionally, in this example the accordion screen 24 is mounted to the interior transverse side 156 of the assembly rather than to the exterior transverse side 158 as shown in the previous example. Also, the vertical upper portion of the door 150 is adjacent an upper frame or header 162 with the opposing vertical side being defined by a sill 164. In this example, the center panel 166 is provided as a translucent material such as glass. This is not only decorative, but in this example allows for easy viewing there through.

As with the previous example, the frame 160 may comprise an overhang 168 on both lateral sides of the frame 160 as well as optionally protruding upward above the header 162. While the fascia 50 is not shown in this example it may be added thereto for decorative or additional weatherproofing.

Looking to FIG. 15 is shown an end view of this example with the side frame 160 removed to show the structure of the internal components. As with the previous example, a door gasket 70 is provided adjacent the interior surface 170 of the outswing door 15 to keep fluid from passing there by. Directly below the door gasket 70 is a transversely downwardly sloping surface 172 which will direct fluid into a fluid channel 174. The fluid channel 174 will direct fluid laterally outward toward the lateral edges of the sill where transverse channels (not shown) may be provided through the front surface 176 of the third extrusion 178 or alternatively, vertical fluid channels (also not shown) may be provided at the ends thereof. In one example, a portion of the lateral ends (frames 160/161) of the fluid channel 174 may provide an opening for fluid to be transferred there past. As shown in FIG. 15, the third extrusion 178 may be removably attached to the second extrusion 180 by way of clips 182-184. In addition, at the forward transverse surface 176 of the sill assembly, a plurality of clips 186 may be provided for removable attachment of a fascia component 274 as shown in FIG. 35 or other structure for added function, or ornamentation.

As shown, the second extrusion 180 of the sill assembly may provide a threshold bead 188 for attachment of the door gasket 70 therein as well as a surface adjacent thereto to provide a tread 190. In one example, the threshold bead 188 in one example allows for a single, continuous door gasket 70 which can bend around the corners of the door frame. In the example shown, transversely rearward of the second extrusion 180 may be provided a first extrusion 192 also removably attached to the second extrusion 180 by way of a plurality of clips 194 which are engaged into clip receivers 196 of the second extrusion 180. In the example shown, the first extrusion 192 is removably attached to the second extrusion 180 in such a manner as to be vertically reversible. To this end, one vertical surface of the first extrusion 192 comprises a tread surface 198 while the opposing vertical surface comprises an accordion screen channel 204 or track functionally equivalent to the channel 132 of the previous example. Looking to FIG. 16, when the first extrusion 192 is vertically reversed and attached to the second extrusion 180 the tread surface 198 is in the vertical upward position where it provides support structure for a person walking thereupon. In this example, the accordion screen 24 may not be utilized.

In the Example of FIG. 16, the accordion screen is not utilized.

It is understood that once installed, the door apparatus, including the sill assembly may be disassembled for example to remove the accordion screen, or to replace any of the components for upgrade or repair.

Looking to FIGS. 17 and 32-33 is another example utilizing the sill assembly 44 of FIGS. 1-4 with some modifications thereto. In FIG. 17, only one door 212 is shown, and FIG. 33 is shown a detail of the overlapping double doors of FIG. 32. In this assembly, the same extrusions 106, 88, and 110 as shown in FIG. 5 may be utilized. Likewise the end caps 64 may also be utilized, as well as the door frame portions 46/48. In the cutaway view of FIG. 17, the overlap 58 can be easily seen protruding from a brickmold portion 206 of the frame. As can be seen in this example, a plurality of mullions 208 are positioned laterally between the frames 46/48 with a window or other panel 210 positioned therebetween. The door gasket 70 previously described may be used to seal both the frames 46/48 and mullions 208 to the (inswing) doors. It is to be understood that the door 214 extends to the opposing frame 48, or to a laterally opposing mullion 208 or equivalent structure.

The hinge side of the doors 212/214 will generally be at the frames 46/48, or may alternatively be at the mullions 208. In addition, the latch may engage the frames 46/48, mullion 208, or may engage a striker plate 216 positioned on or formed with the sill and/or the vertically opposed header 40. Use of such striker plates is well known in the art of exterior and interior doors such as the double doors shown in FIG. 32-33.

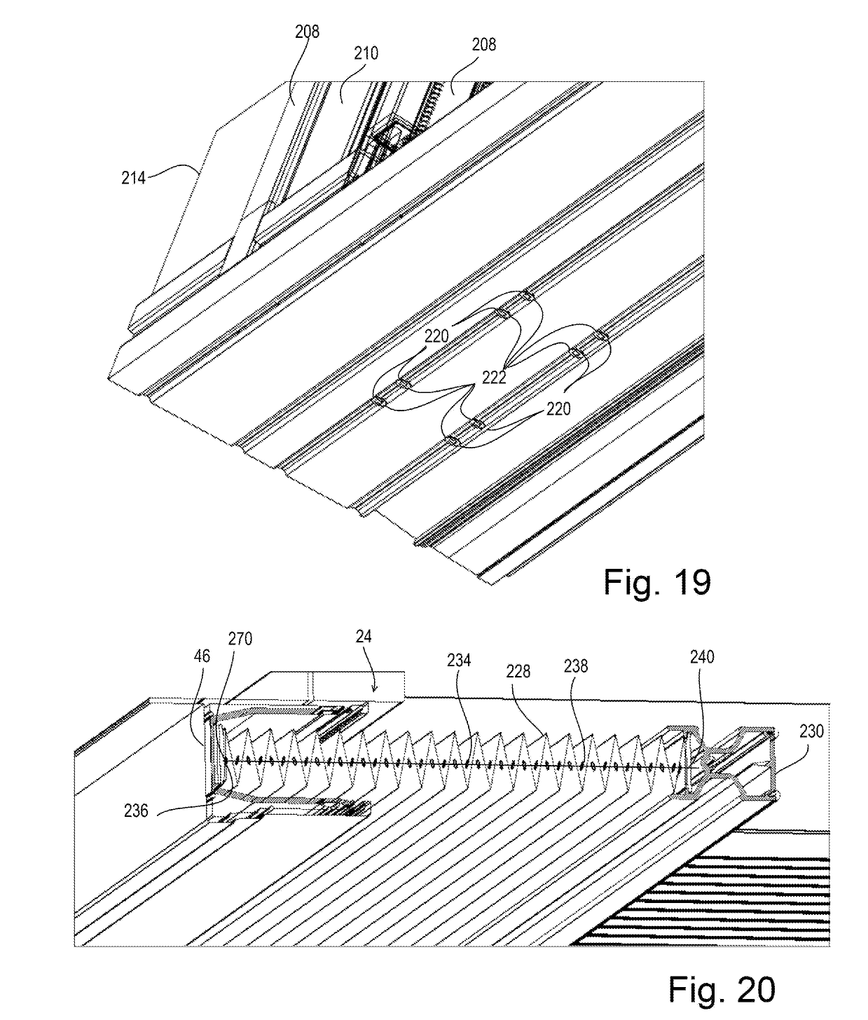

In the example of FIGS. 17/18/32-33 it can be seen that no accordion screen is currently installed in this assembly. The accordion screen channel 132 is shown with a (removable) screen track cover 202 installed therein. As the mullions 208 may not extend transversely forward of the inner transverse edge 218 of the channel 132, the mullions will not interfere with movement of the accordion screen 24 when installed. Looking to FIG. 19, it can be seen how in one installation, the mullions 208 are attached to the sill assembly by way of a plurality of fasteners 220 passing through voids 222 the sill assembly into the lower vertical surface of the mullions 208. In one form, the fasteners engage (thread into) mullion boots 224 over which a vertical portion of the mullions 208 are attached or fitted.

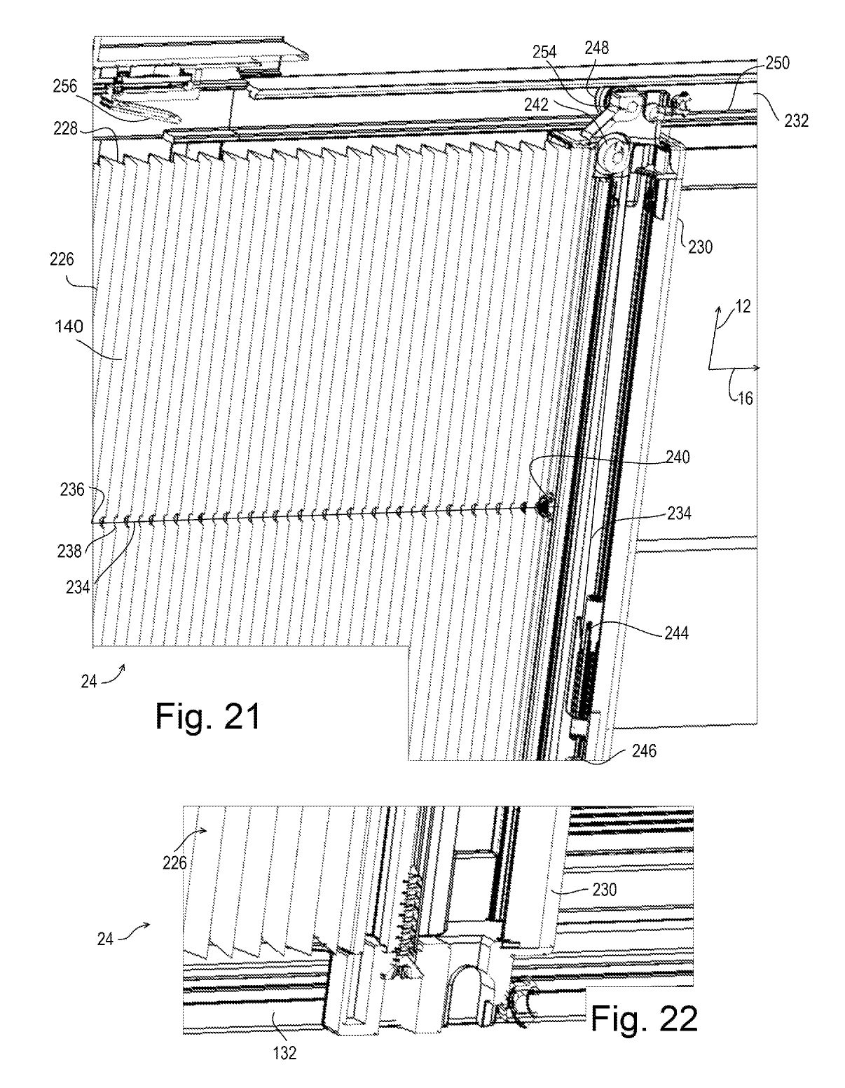

A more detailed description of several components of the accordion screen assembly will now be provided. Looking to FIG. 21 is shown a cutaway view of the upper left portion of the accordion screen assembly 24. In this view, the accordion screen 24 comprises a pleated screen mesh material 140 being folded into a plurality of pleats 228. The term mesh used herein to define a woven, pressed, or otherwise produced material which is overall generally translucent, allows air to flow substantially freely there though, and generally does not allow the passage of insects. By using the sill/mullion arrangement described, as the slide bar 230 is repositioned laterally 16 toward a closed position, the pleats 228 unfold so that the pleated material covers the area defined by the door frame components 46, 48, 40, and sill 44. In this way, the door 22 can be opened while the accordion screen assembly 24 is closed keeping animals such as rodents and insects out of the building while allowing airflow through the doorway.

In the example shown, the lower portion of the accordion screen assembly 24 shown in FIG. 22 rides within one of the channels 132 previously described. Likewise the upper portion shown in FIG. 21 rides within a channel 232 in the upper frame or header 40.

FIG. 21 also shows a mechanism to assist in opening and closing the accordion screen assembly 24. As shown in this example, the mechanism comprises a plurality of strings 234 which may be attached at a first end 236 to the frame 46 (see FIG. 20) by way of string anchors 270. Each string may be formed of twisted or braided filaments, monofilament, and may be made of natural materials, metals, polymers, or combinations thereof. Each string 234 then passes through a plurality of surfaces defining voids 238 in each of the pleats 228 and then through a grommet 240 or similar orifice provided in the slide bar 230. The string then passes upwards over a string wheel 242 (See FIG. 21) or similar redirecting apparatus where upon the string then passes downward and attaches to a string tie-down 244 (See FIG. 31) and the string tie down 244 may then be attached to a weight or series of weights 246. A spring 276 may be incorporated between the string tie down 244 and the weights 246. In the example shown in FIG. 31, the string tie-down has a vertical surface defining a void 288 there through. Each string passes though this surface, and passes around one of several indexing slots 290. The string may then be cleated to a fin or cleat 292. In this way, the string 234 aligns the surfaces defining voids 238 in each of the pleats 228 keeping the pleated material 140 from bowing when in a closed position across the doorway. In addition, the weights 246 may provide closing assistance to the accordion screen 24 overcoming some or all of the friction encountered by the assembly as it slides along the channels 132 and 232.

In FIG. 25 and in FIG. 26 a balance wheel 272 can be seen set at an offset angle to the channel so as to redirect the bottom (sill) string to loop around an eye 278 of a weight 280 and then pass over the string guide in the carriage 252 so that a single string may be used for the top (header) string and bottom (sill) string. Again, a spring 282 may be utilized similar to the spring 276.

To further reduce friction effects and to maintain the slide bar 230 in a fully vertical orientation, the slide bar 230 and components housed there within may be suspended by a plurality of transversely adjacent guide wheels 248 which each ride upon a lateral shelf 250 of the channel 232.

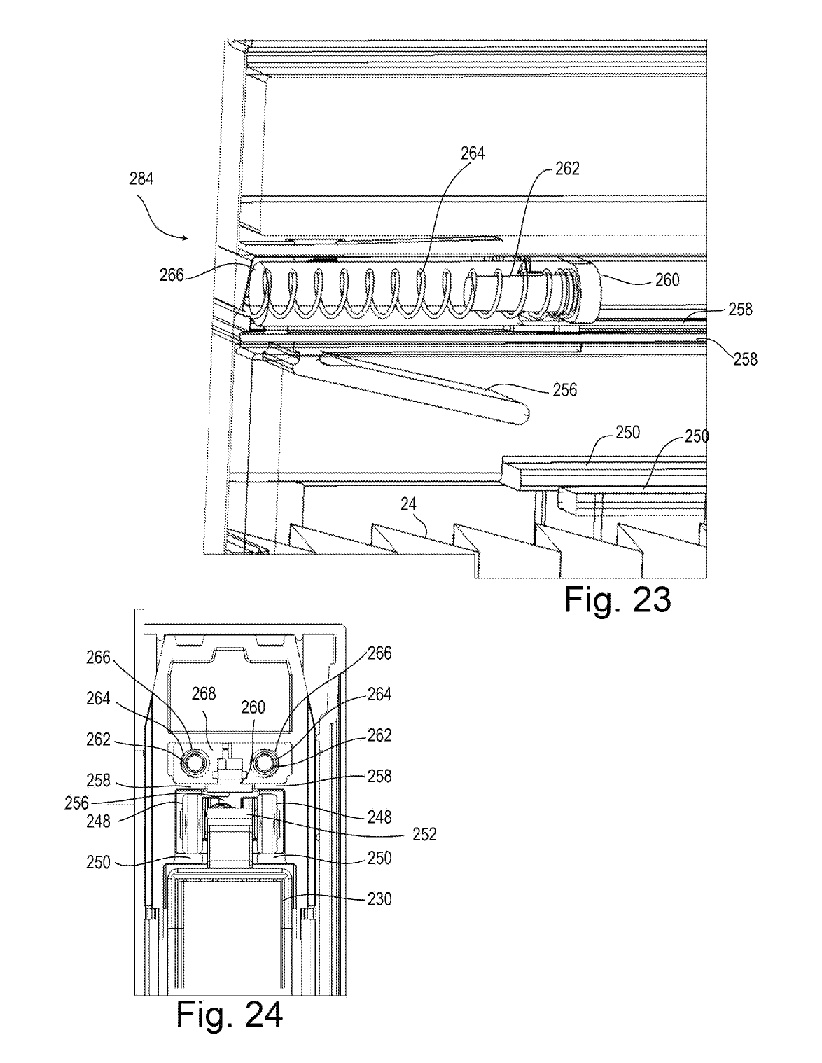

In one example shown in FIGS. 23 and 24 the apparatus may include a stop assembly 284 to restrain abrupt opening of the accordion screen 24. In this example it can be seen how the slide bar 230 and guide wheels 248 are attached to a carriage 252 having a lateral face 254. As the accordion screen 24 is opened, the lateral face 254 will contact an arm 256 protruding downward through an opening between two lateral shelves 258. The arm 256 is shown as a cantilevered arm of a sliding component 260 supported upon the shelves 258 and allowed to slide a short distance thereupon. In the example shown, the sliding component comprises a plurality of posts 262 with a compression spring 264 fitted thereabout. The post 262 and compression spring 264 reposition within a female surface 266 of a fixed spring housing 268.

As the accordion screen is opened, the lateral face 254 will contact the cantilevered arm 256, and compress the spring 264, reducing compression forces on the frame 26 and accordion screen 24.

In one example, the screen assembly may be inserted into a cavity in the brick mold and attached by way of a hook and loop fastener.

FIG. 32 and show an astragal 286 which may be formed of aluminum, such as by extrusion. The astragal overlaps both opening doors 212, 214 and in combination with a malleable seal, forms a watertight barrier between the doors, while allowing the double doors to open.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. An exterior door sill for fluid transfer away from an exterior surface of an exterior door having a lateral width, vertical height, and transverse depth, the door sill comprising:
a. the exterior door sill extending the lateral width of the door, positioned substantially below the door and having a first lateral fluid channel below an exterior surface of the door;
b. wherein the forward surface of the lateral fluid channel forms a first lateral bulkhead having at least one surface defining a first transverse fluid passageway there through;
c. a tread portion extending transversely forward of the door;
d. a second transverse fluid passageway below the tread portion;
e. wherein the forward surface of the lateral fluid channel forms a second lateral bulkhead having at least one surface defining a second transverse fluid passageway there through laterally offset from the first transverse fluid passageway;
f. wherein fluid flows below an upper surface of the exterior door sill and above an upper surface of the exterior door sill from the first lateral fluid channel transversely through the first transverse fluid passageway, laterally through the second lateral fluid channel and transversely through the second transverse fluid passageway transversely away from the exterior surface of the door.

2. The exterior door sill as recited in claim 1 further comprising:
a. a lateral accordion screen door channel;
b. a surface defining a third lateral fluid channel below the screen door channel;
c. wherein the screen door channel is in fluid communication with the third lateral fluid channel so that fluid flows from the screen door channel to the third lateral fluid channel by gravity.

3. The exterior door sill as recited in claim 1 wherein the door further comprises hinges on the exterior surface of the door so as to permit the door to swing outwardly.

4. The exterior door sill as recited in claim 3 further comprising a lateral accordion screen channel on the exterior side of the door.

5. The exterior door sill as recited in claim 1 wherein the door further comprises hinges on the interior surface of the door so as to permit the door to swing inward.

6. The exterior door sill as recited in claim 5 further comprising a lateral accordion screen channel on the exterior side of the door.

7. The exterior door sill as recited in claim 1 wherein the screen door channel comprises a removable channel cover receiving surface.

8. The exterior door sill as recited in claim 7 further comprising a removable channel cover removably fitted to the cover receiving surface.

9. The exterior door sill as recited in claim 1 wherein at least one portion of the door sill is functional as a door sill when vertically inverted.

10. The exterior door sill as recited in claim 1 wherein the door sill comprises a plurality of interoperating and removably interconnected portions substantially extending the lateral width of the door sill.

11. The exterior door sill as recited in claim 10 wherein each of the interoperating and removably interconnected portions is an extruded component.

12. The exterior door sill as recited in claim 1 wherein the door sill comprises a removable tread portion positioned directly below the door.

13. The exterior door sill as recited in claim 1 comprising a continuous malleable seal around the doorway.

14. A screen assembly comprising:
a. a pleated accordion screen having a first lateral side attached to a doorway;
b. the accordion screen having a second lateral side repositionable from an open position adjacent the first lateral side to a closed position at an opposing lateral side of the doorway;
c. at least one laterally aligned surface defining a string void through each pleat of the accordion screen;
d. a string a string passing though each laterally aligned string void;
e. the string having one end attached to a counterbalance weight facilitating closing of the screen assembly.

15. The screen assembly as recited in claim 14 further comprising;
a. a sill positioned below the pleated accordion screen;
b. a lateral accordion screen channel in the sill;
c. a surface defining a lateral fluid channel below the screen channel;
d. wherein the screen channel is in fluid communication with the lateral fluid channel so that fluid flows from the screen channel to the lateral fluid channel by gravity.

16. The screen assembly as recited in claim 14 further comprising;
a. a slide bar attached to the second lateral side of the accordion screen;
b. a carriage suspended from a channel attached to a doorway adjacent the screen assembly; and
c. wherein the slide bar is attached to and suspended from the carriage.

17. The screen assembly as recited in claim 16 wherein the carriage comprises at least one string wheel around which the string traverses between the accordion screen and a weight suspended by the string below the carriage inside the slide bar.

18. The screen assembly as recited in claim 16 wherein the carriage comprises at least one balance wheel set at an offset angle to the channel wherein the balance wheel redirects the string for use through at least two sets of laterally aligned surfaces defining a string voids through each pleat of the accordion screen.

19. The screen assembly as recited in claim 16 further include a sting tie down comprising:
a. a surface defining a vertical void there through;
b. a plurality of indexing surfaces on a lower region thereof; and
c. a plurality of cleats extending horizontally from the exterior surface thereof.

20. The screen assembly as recited in claim 14 wherein:
a. the screen is interior of an exterior entry door;
b. the entry door opens outward.
